(19) United States
(12) Patent Application Publication
(10) Pub. No.: US 2023/0224540 A1
(43) Pub. Date: Jul. 13, 2023

(54) SYSTEMS AND METHODS FOR GENERATING A PERSONALITY PROFILE BASED ON USER DATA FROM DIFFERENT SOURCES

(71) Applicant: ALLSTATE INSURANCE COMPANY, Northbrook, IL (US)

(72) Inventors: Anuradha KODALI, Freemont, CA (US); Chanakykumar BHAVSAR, Naperville, IL (US); Timothy W. GIBSON, Barrington, IL (US)

(21) Appl. No.: 17/574,304

(22) Filed: Jan. 12, 2022

(51) Int. Cl. H04N 21/442; H04N 21/466; H04N 21/258; H04N 21/45

(52) U.S. Cl. CPC H04N 21/44226; H04N 21/4666; H04N 21/25891; H04N 21/4532

(57) ABSTRACT

Implementations claimed and described herein provide systems and methods for behavior assessment for an individual. In one implementation, user data for the individual is obtained from one or more digital sources. Categorized user data is created by transforming the user data into a platform independent format. The categorized user data is associated with a plurality of content-based bins. One or more behavioral insight categories are determined from the categorized user data. A plurality of behavioral metrics is determined based on the one or more behavioral insight categories and the categorized user data. A personality profile for the individual is generated by converting the plurality of behavioral metrics into one or more scores. A risk assessment for the individual is generated based on the personality profile.

### FIELD

Aspects of the presently disclosed technology relate generally to risk assessment techniques and more particularly to generating a personality profile for calculating a risk assessment based on digital footprint from a plurality of disparate sources.

### BACKGROUND

Service provider platforms generally leverage end user preferences for targeting or offering services to end users. For example, some service provider platforms may utilize demographics to understand a target market of users and offer services accordingly. In some instances, a service provider platform may analyze user preferences on an individual level to offer services to a specific user. However, this information is often one-dimensional, providing limited insight into the individual. For instance, a video streaming service may generally determine which videos to recommend to a user based on a viewing history of the user and other users. As such, any understanding of the individual user is limited to a likelihood that a user will view certain videos. Such limited insight is insufficient for complex services, such as risk assessment, involving various facets of an individual. It is with these observations in mind, among others, that various aspects of the present disclosure were conceived and developed.

### SUMMARY

Implementations described and claimed herein address the foregoing by providing systems and methods for behavior assessment for an individual. In one implementation, user data for the individual is obtained from one or more digital sources. Categorized user data is created by transforming the user data into a platform independent format. The categorized user data is associated with a plurality of content-based bins. One or more behavioral insight categories are determined from the categorized user data. A plurality of behavioral metrics is determined based on the one or more behavioral insight categories and the categorized user data. A personality profile for the individual is generated by converting the plurality of behavioral metrics into one or more scores. A risk assessment for the individual is generated based on the personality profile.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates an example system for generating a personality profile based on a digital footprint.

FIG. 2 illustrates an example system for transforming user data from disparate digital sources into categorized user data for generating a personality profile.

FIG. 3 illustrates an example system for generating an activity timeline.

FIG. 4 illustrates an example system for determining an activity pattern from an activity timeline.

FIG. 5 illustrates an example system for determining an activity pattern from an activity timeline.

FIG. 6 illustrates an example system for generating a content hierarchy.

FIG. 7 illustrates an example system including a behavioral insight categories generator to generate behavior metrics.

FIG. 8 illustrates an example system which uses a behavioral insight categories generator to generate behavior metrics.

FIG. 9 illustrates an example system for generating behavioral dimensions of a personality profile from behavior metrics.

FIG. 10 illustrates an example system for generating a personality profile from behavioral dimensions.

FIG. 11 illustrates an example network environment with one or more computing devices for generating a personality profile based on a digital footprint of user data from different digital sources.

FIG. 12 illustrates example operations for generating a personality profile.

### DETAILED DESCRIPTION

Aspects of the present disclosure involve systems and methods for generating a personality profile from a digital footprint of an individual. The digital footprint may be based on user data from a variety of disparate sources. Generally, user data is collected from a plurality of sources at varying frequencies, using differing schemas, and having various characteristics. The presently disclosed technology generates a personality profile providing an understanding of an individual, including behavior.

The user data can include multiple data files in different formats. In one aspect, the system categorizes the user data into one or more content-based bins (e.g., a location bin, a purchases bin, an activity bin, a fitness bin, a social network bin, and/or a personally identifiably information (PII) bin), standardizing the data from the different, third-party platforms. Stated differently, the system transforms and normalizes the data into a platform independent data format, permitting data from disparate sources to be aggregated and categorized. By way of example, the system recognizes that a first data format for a first platform (e.g., a social media platform) has a first data structure defining a “connection” and a second data format for a second platform (e.g., for a gaming platform) has a second data structure defining a “friend.” The system normalizes these different data formats by recognizing that the “connection” of the first data format and the “friend” of the second data format represent similar underlying information despite the different data formats. As such, the two different data structures may be transformed and normalized into a platform independent data format and categorized into one or more common content-based bins (e.g., social bin and the PII bin).

The data from different platforms may be aggregated and categorized into different formats into the content-based bins using a multi-data source personality profile generator. In one example, the multi-data source personality profile generator generates a content hierarchy (e.g., including various categories and sub-categories of the) and an activity timeline (e.g., action items in a chronological sequence) using the categorized user data. Patterns from the content hierarchy and the activity timeline can be identified, combined, and leveraged to generate a plurality of behavioral insight categories and behavioral metrics corresponding to the behavioral insight categories. The plurality of behavioral insight categories and behavioral metrics may be used to generate a knowledge graph (e.g., via a JavaScript Object Notation (JSON) data structure) providing a multi-dimensional representation of a specific individual. For instance, the behavioral insight categories and behavioral metrics are used to calculate lifestyle index values and brand personality values.

The presently disclosed technology generates a digital footprint for a specific individual in a platform independent format by transforming data obtained from disparate sources in different digital formats. The digital footprint may be used to generate a knowledge graph and/or personality profile representing a sophisticated understanding about the behavior of the specific individual. Accordingly, the presently disclosed technology provides a comprehensive understanding of how the behavior of the specific individual affects risk. For example, restaurant visit data (e.g., aggregated from different digital sources) can be used to generate the content hierarchy (e.g., based on content items of the food orders), the activity timeline (e.g., based on action items representing when the restaurant visits occurred), and/or multiple behavioral dimensions for risk assessment, such as a mobility dimension indicating a driving risk and a health dimension indicating a health risk. A JSON data structure of such categorized data provides accurate binning and fast retrieval of the data for analytics purpose (e.g., for presentation at various graphical user interfaces (GUIs)). The framework of the multi-data source personality profile generator thus provides an optimized and sophisticated understanding of and estimations regarding behavior of one or more specific individuals, thereby improving risk assessment for actuarial pricing, data privacy risk assessments, product recommendation placement, target advertisement placement, and/or the like. Additional advantages of the presently disclosed technology will become apparent from the detailed description herein.

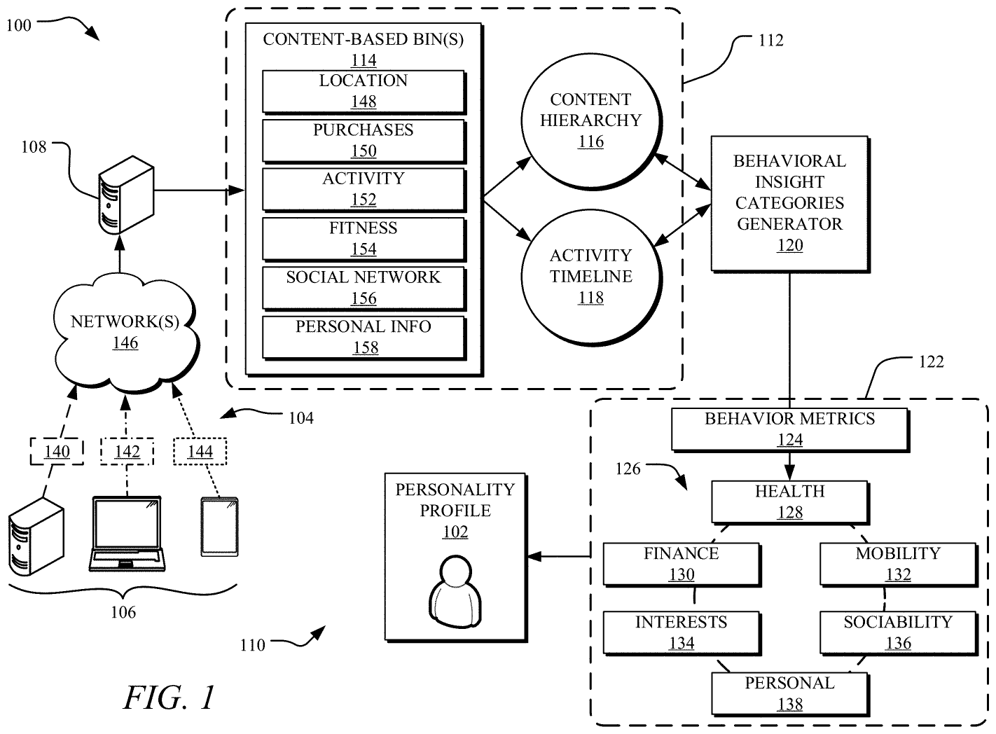

To begin a detailed description of an example system 100 for generating a personality profile 102, reference is made to FIG. 1. The personality profile 102 may be used for an insurance policy risk assessment, a data privacy risk assessment, a product recommendation, and/or other risk assessments or targeted recommendations or placements. In one implementation, the system 100 receives user data 104 for one or more individuals from one or more digital sources 106 sending different types of data (e.g., with different data formats), for instance, to one or more server device(s) 108 operating a multi-data source personality profile generator 110. The multi-data source personality profile generator 110 can include a data aggregator 112 to categorize and model the user data 104 into one or more content-based bin(s) 114 and model the categorized user data into a content hierarchy 116 and/or an activity timeline 118.

The data aggregator 112 extracts the data from various different data types (e.g., with different purposes for different applications) and transforms and standardizes the different data types into a common data structure (i.e., a platform independent data format) by generating and associating one or more identifiers corresponding to the content-based bin(s) 114 and/or extracting the data into a previously defined data structure. Action items represented by the user data 104 can be tagged with previously defined labels and/or scoring components to assign a likelihood score to the user data 104 corresponding to the previously defined labels.

In one implementation, a behavioral insight categories generator 120 uses the user data 104 to generate interest category identifiers and content identifiers and, from the interest category identifiers and content identifiers, other identifiers and correlations between action items as part of a personality profile generation process 122. For instance, a plurality of behavior metrics 124 can be determined and used to generate scores (e.g., labels) for a plurality of behavioral dimensions 126 in a many-to-many relationship. Any particular behavior metric 124 can apply to multiple behavioral dimensions and any particular behavioral dimension can receive multiple behavior metrics 124. A health dimension 128, a finance dimension 130, a mobility dimension 132, an interests dimension 134, a sociability dimension 136, a personal identity dimension 138, and/or other dimensions may be generated from behavior metrics 124. Using the behavioral dimensions 126, the personality profile 102 may be generated. For example, the personality profile 102 may be generated by indicating a plurality of lifestyle index values, brand personality values, and/or the like. The personality profile 102 can be viewable using a GUI rendering a visual presentation of the multi-data source personality profile generator 110 at various layers of analysis and detail. For instance, the system 100 can provide a timeline view, a content view, a personality profile summary view, and/or other views as discussed herein.

The personality profile 102 may be optimized by transforming the different data received in various data formats into a highly structured, detailed, consistent, and viewable data structure that is platform agnostic. For instance, the multi-data source personality profile generator 110 can receive (e.g., at the data aggregator 112) first user data in a first data format 140 from a first digital source of the one or more digital sources 106 (e.g., a credit card service); second user data in a second data format 142 from a second digital source of the one or more digital sources 106 (e.g., a social network account); and/or third user data in a third data format 144 from a third digital source of the one or more digital sources 106 (e.g., a wearable device application). The multi-data source personality profile generator 110 can receive the user data 104 at the server device(s) 108 via one or more network connections provided by one or more network(s) 146.

The first data format 140, the second data format 142, and the third data format 144 can be different data formats, different types of data, for different purposes, and arranged in different data structures, yet the data aggregator 112 is still able to convert the user data 104 into highly-functional, inter-operable, categorized user data having a common schema. The data aggregator 112 assess the various portions of the user data 104 files (e.g., a header, a body, a timestamp, a sending/terminating location or address, etc.) and generates one or more tags, labels, categories, and/or other data structures (e.g., indicating supplemental meta-data) to associate with the user data 104 (e.g., action items represented by the user data 104). Converting the user data 104 into the categorized user data can further include associating the action items represented by the user data 104 with one or more predefined categories, such as one or more (e.g., or all) of the content-based bin(s) 114 including a location bin 148, a purchases bin 150, an activity bin 152, a fitness bin 154, a social network bin 156, and/or a PII bin 158. Accordingly, from this categorized user data, the content hierarchy 116, the activity timeline 118, the interest category identifiers, the content identifiers, and/or the behavioral dimensions 126, the personality profile 102 can be constructed.

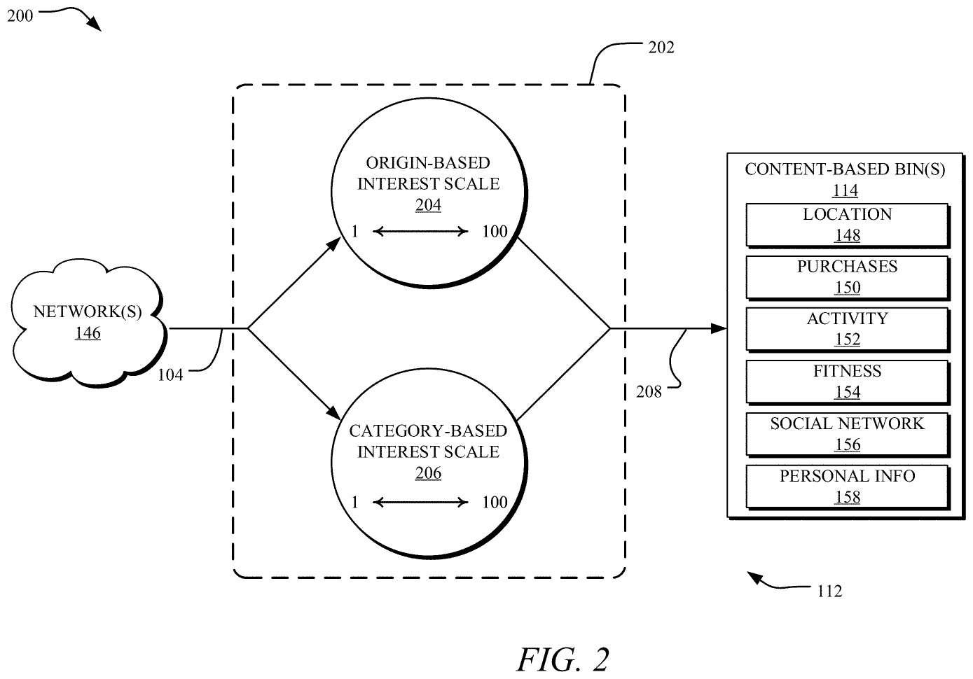

Turning to FIG. 2, an example system 200 including the data aggregator 112 can have an input data scaling system 202 for generating a weight, relevance, interest, and/or importance score associated with the user data 104 (e.g., individual action items represented by the user data 104). The input data scaling system 202 can include an origin-based interest scale 204 and/or a category-based interest scale 206 for generating an evidence confidence rating 208 for the user data 104.

For instance, the user data 104 (e.g., originating from a variety of different digital sources 106) can represent a plurality of action items, and the input data scaling system 202 can generate a plurality of evidence confidence ratings (e.g., between 1 and 3; 1 and 5; between 1 and 10; 1 and 100; 1 and 1000; 0 and 3; 0 and 5, etc.) associated with the plurality of action items, such that the plurality of action items are weighted, scaled, and/or adjusted to increase or decrease the impact of the action items on the analysis downstream of the input data scaling system 202 performed by the multi-data source personality profile generator 110.

The evidence confidence rating 208 can indicate a level of interest (e.g., of a user or specific individual) associated with the user data 104. The input data scaling system 202 can generate the evidence confidence rating 208 using the origin-based interest scale 204, for instance, based on how the action item of the user data 104 originated or how a user caused the action item to occur. The origin-based interest scale 204 can generate a rating between 1 and 100 (or any range) based on what type of activity the user engaged in to perform the action item. In some instances, a search action item can receive a lowest rating (e.g., between 0 and 25); a website visit action item can receive a second lowest rating (e.g., between 25 and 50); a purchase, a location of a visit, a membership or subscription, a health record, a post, a fitness regime, a friend network, or a clicked ad action item can receive a highest rating (e.g., between 75 and 100); and/or a watched, a “liked,” a comment, or a game action item can receive a second highest rating (e.g., between 50 and 75).

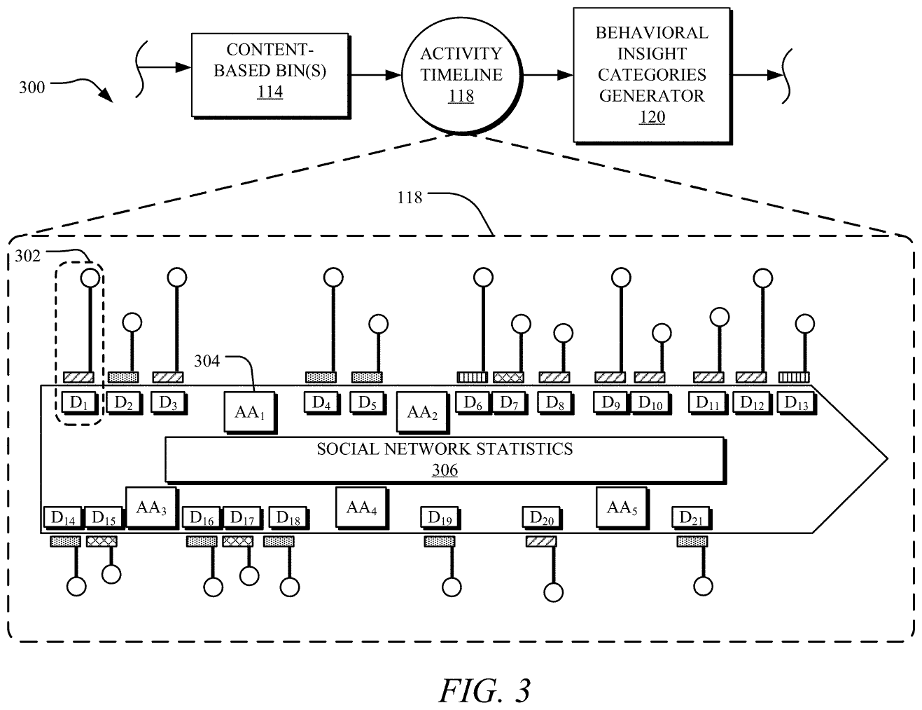

Additionally or alternatively, the evidence confidence rating 208 can be generated using the category-based interest scale 206 (e.g., to generate a second evidence confidence rating 208 and/or to generate a single evidence confidence rating 208 in combination with the origin-based interest scale 204). The category-based interest scale 206 can generate the evidence confidence rating 208 based on a behavioral insight category that the input data scaling system 202 determines to be related to the action item. For instance, the category-based interest scale 206 can receive the behavioral insight category from the behavioral insight categories generator 120 in an iterative/recursive feedback loop and weigh action items associated with higher-impact behavioral insight categories higher than action items associated with lower-impact or no behavioral insight categories. In some instances, the user data 104 and/or data generated downstream from the user data 104 can be scaled or weighted at various points in the data flow of the multi-data source personality profile generator 110. For instance, the input data scaling system 202 can include additional interest scales, such as a frequency interest scale to weigh the user data 104 based on a frequency of occurrences of the action items (e.g., based on the content hierarchy 116) and/or behavioral insight categories associated with the action items (e.g., generated by the behavioral insight categories generator 120). One or more activity timeline-based interest scales can weigh or scale the user data 104 based on activity patterns corresponding to the action items represented by the activity timeline 118 (e.g., as discussed in greater detail below regarding FIGS. 3-5). In some instances, the evidence confidence ratings 208 are generated by artificial intelligence such as supervised machine learning, neural networks, and other algorithms or techniques trained through one or more iterative and validation processes using historical user data 104 and historical personality profiles 102 generated from the user data 104 to calculate the evidence confidence rating 208 and/or other data scales, weights, or coefficients.

In some examples, the system 200 (e.g., using the data aggregator 112) can categorize the user data 104 into categorized user data by associating the action items with the content-based bin(s) 114. For instance, action items represented by the user data 104 can be categorized and/or tagged into the location bin 148, such as a location services action item, a social media tagging action item, a location visit action item (e.g., generated by an appointment or scheduling application or a food/restaurant reservation application), a ride-share/taxi service, any other application that uses location-sharing functionality (e.g., via a GPS sensor), and the like. The action items represented by the user data 104 can be categorized and/or tagged into the purchases bin 150, such as e-commerce activity action items, browsing data action item, e-receipts (e.g., emails) action items, social media marketplace action items, subscription action items (e.g., for applications, news sites, magazines, based on renewal emails, etc.), credit card service action items, bank statement action items, rides-share/taxi orders, other mobile application services, and the like.

In some examples, action items represented by the user data 104 can be categorized and/or tagged into the activity bin 152. The activity bin 152 can include one or more sub-categories indicating how action item are consumed/performed. For instance, the activity bin 152 can categorize the action item into a read sub-category, a listened sub-category, a watched sub-category, a searched sub-category, a browsed sub-category, an applications/gaming sub-category, and/or a home monitoring sub-category. Action items categorized into the activity bin 152 can include google and other web service action items, music application action items, newspaper and blog action items (e.g., subscriptions), streaming services (e.g., Netflix®, Amazon Prime®, HBO®, Hulu®, and the like), mobile application action items, Internet-of-things action items, and the like. In some examples, action items represented by the user data 104 can be categorized and/or tagged into the fitness bin 154. For instance, the fitness bin 154 can categorize the action items related to health, diet, sleep, fitness, and/or physical activity. Action items categorized into the fitness bin 154 can include fitness device data (e.g., an Android® device, an Apple® device, etc.) action item, a Fitbit® action item (e.g., a steps or daily steps action item, a biking action item, a physical challenge action item, a calories action item, a sleep duration action item, and the like), a gym subscription action item, a gym purchase action item, a diet plan subscription action item, a restaurant visit or reservation action item, and the like.

In some examples, action items represented by the user data 104 can be categorized and/or tagged into the social network bin 156. The social network bin 156 can include action items originating from actions occurring on one or more social networks (e.g. Facebook®, Twitter®, LinkedIn®, Reddit®, Bumble®, etc.), such as a post action item, a target ad placement action item, a target ad selection action item, a like action item, a comment action item, an upvote or downvote action item, a friend association action item, a friend network action item, and the like. In some examples, action items represented by the user data 104 can be categorized and/or tagged into the PII bin 158. For instance, the PII bin 158 can categorize action items related to or that include private information, identifying information, or personal interests information, such as demographic information, education information, employment information, social network account information, genre/category interest information (e.g., based on activity with digital media), services information (e.g., address, phone number, area code, email address, etc.), and the like.

It is to be understood, as indicated above, that any action item in the user data 104 can be associated with one or multiple content-based bin(s) 114, as described above. For instance, an action item corresponding to ordering a rideshare to the gym can be associated with at least the location bin 148 (e.g., arrival/destination GPS data); the purchases bin 150 (e.g., transactional data, credit card data); the activity bin 152 (e.g., mobile application activity data); and the fitness bin 154 (e.g., gym usage data, exercise time data, etc.). Moreover, any action items discussed herein can be used as a predefined action item and/or training action item for identifying matching action items from the user data 104 (e.g., based on a statistical likelihood that the action item from the user data 104 matches the predefined action item). Any action items not listed above may be recognized and categorized by the system 200 based on a similarity comparison (e.g., using supervised machine learning) to identify which of the action items explicitly discussed herein are most similar to the unlisted action item. In some instances, the system 200 can receive the action items by receiving authentication input from the user linking the multi-data source personality profile generator 110 to the various applications and services providing the user data 104 discussed herein.

FIG. 3 illustrates an example system 300 of the activity timeline 118 generated from and representing the categorized user data. The activity timeline 118 can be a data structure organizing the categorized user data chronologically and associated with the corresponding content-based bin(s) 114. An activity timeline 118 representing one year of action items is depicted in FIG. 3.

In some instances, a first action item 302 can represent a first action and can include a plurality of descriptive identifiers such as “bought sports apparel” (“D₁”) at a particular time (e.g., January 3) on the activity timeline 118 corresponding the content of the action item and/or the data extracted into the content-based bin(s) 114. Additional data can be associated with the first action item 302 on the activity timeline 118 such as an action frequency corresponding to identical action items, the values generated by the input data scaling system 202, and the like. A second action item (“D₂”) can be “searched for live Super Bowl telecast; and a third action item (“D₃”) can be “ordered wings.” The activity timeline 118 can also generate account actions, such as a first account action 304 (“AA₁”) being “changed Facebook relationships status;” a second account action (“AA₂”) being “created LinkedIn® profile;” a third account action (“AA₃”) being “became Amazon Prime® member;” a fourth account action (“AA₄”) being “subscribed to HBO®;” and/or a fifth account action (“AA₅”) being “subscribed to Hulu®.” Moreover, the activity timeline 118 can include additional action items interspersed with the account actions, such as a fourth action item (“D₄”) being “searched for roof leaks;” a fifth action item (“D₅”) being “posted for lawn mower suggestions,” a sixth action item (“D₆”) being “posted for lawn mower suggestions;” a seventh action item (“D₇”) being “clicked ads for lawn mower suggestions;” an eight action item (“D₈”) being “bought lawn mower;” a ninth action item (“D₉”) being “reserved hotel;” a tenth action item (“D₁₀”) being “booked flight;” an eleventh action item (“D₁₁”) being “bought Christmas lights;” a twelfth action item (“D₁₂”) being “bought wall painting;” and/or a thirteenth action item (“D₁₃”) being “posted Merry Christmas and Happy New Year.”

Additionally, in some instances, the action items can include (starting again at a beginning of the activity timeline 118) a fourteenth action item (“D₁₄”) being “search reviews for ‘The Escape Room’;” a fifteenth action item (“D₁₅”) being “watched trailer for ‘The Escape Room’;” a sixteenth action item (“D₁₆”) being “searched for ‘earthquake’,” a seventeenth action item (“D₁₇”) being “donated for earthquake fund;” an eighteenth action item (“D₁₈”) being “searched reviews for “Five Feet Apart’;” a nineteenth action item (“D₁₉”) being “searched reviews for ‘Maiden’;” a twentieth action item (“D₂₀”) being “bought weights;” a twenty-first action item (“D₂₁”) being “searched reviews for ‘Ford vs Ferrari;’” and the like. Moreover, in some examples, the activity timeline 118 includes one or more social network statistics 306, such as aggregations of data values from one or more social network applications (e.g., a number of Facebook® friends; a post frequency rating such as high, medium, or low; a number of LinkedIn® friends; a title of a liked or followed page, and the like).

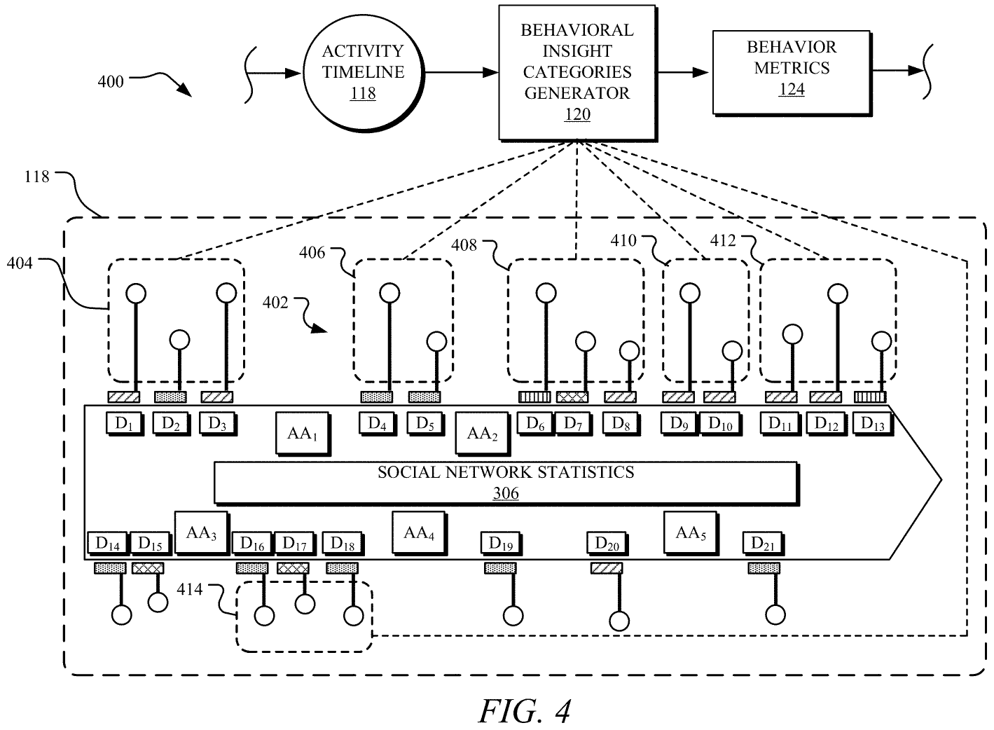

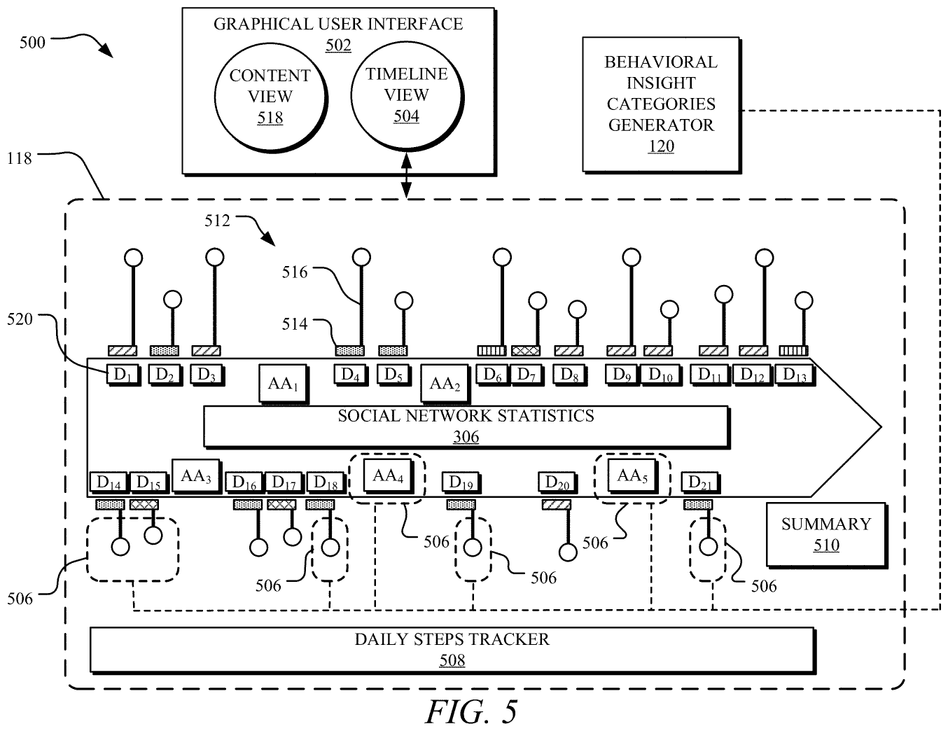

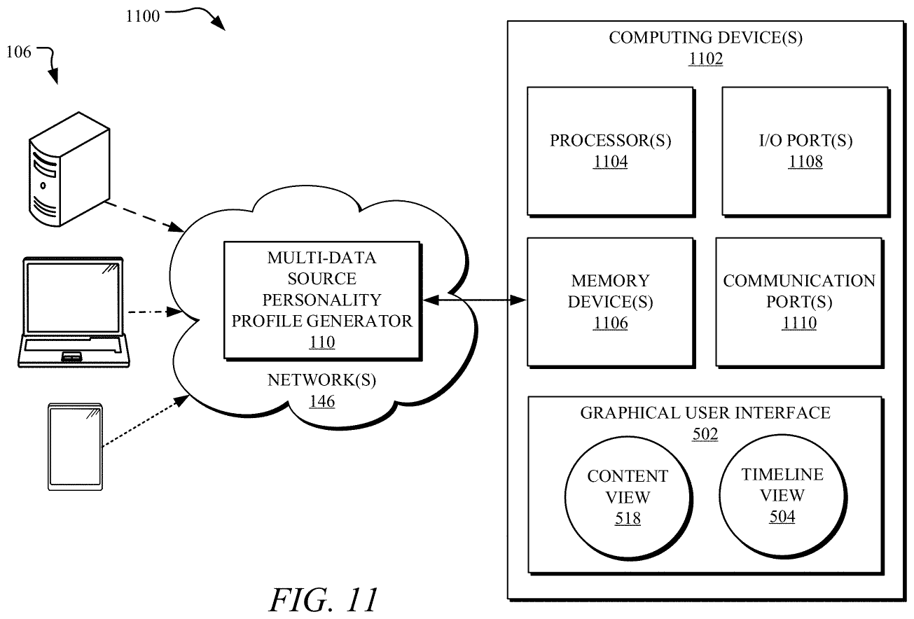

The action items organized according to the activity timeline 118 and/or the category-based interest scale 206 as discussed herein can be used to identify action patterns, from which behavioral insight categories are determined, as discussed below regarding FIGS. 4 and 5. Moreover, the various data associated with the action items (e.g., descriptive identifier, content-based bin 114 associations, etc.) can be stored for quick retrieval and/or presentation at a GUI 502 as a timeline view 504, as discussed below regarding FIGS. 5 and 11.

Turning to FIG. 4, a system 400 can include the behavioral insight categories generator 120 for determining the behavioral insight categories using the activity timeline 118. For instance, the multi-data source personality profile generator 110 can use the behavioral insight categories generator 120 to identify one or more activity patterns 402 from the activity timeline 118 The one or more activity patterns 402 can include one or more action clusters, such as a first action cluster 404 including the first action item D₁, the second action item D₂, and the third action item D₃ based on a correlation to sports. The first action cluster 404 can be a “sports” cluster, even though D₁, D₂, and D₃ involve different types of actions from different content-based bins 114, because the action items occur in a sequence and/or within a predetermined amount of time of each other, and/or because the first action item D₁ relates to buying sports-related apparel, the second action item D₂ relates to searching for a sports-related event (e.g., the Super Bowl), and the third action item D₃ relates to ordering a sports-related food (e.g., chicken wings). In other words, a “sports” content identifier can be generated for D₁, D₂, and D₃ based on determining that D₁, D₂, and D₃ relate to sports (e.g., or another content identifier for another behavioral insight category). Moreover, the behavioral insight category of sports can be generated for the personality profile 102 and cause a behavior metric 124 for a high interest in sports to influence the personality profile generation process 122 generating the behavioral dimensions 126.

Furthermore, the behavioral insight categories generator 120 can identify a second action cluster 406 including the fourth action item D₄ “searched for roof leaks” and the fifth action item D₅ “searched for roof contractor.” The second action cluster 406 is based on both D₄ and D₅ being related to home renovations at a particular time on the activity timeline 118, and a home renovations behavior insight category is generated and/or used to generate one or more home renovations-related behavior metrics 124. A third action cluster 408 can be based on the sixth action item D₆ “posted for lawn mower suggestions;” the seventh action item D₇ “clicked adds for lawn mower suggestions;” and the eighth action item Dg “bought lawn mower.” The third action cluster 408 is identified based on D₆, D₇, and D₈, and can correspond to generating a home, home renovation, lawn, and/or lawn mower behavioral insight category. A fourth action cluster 410 can be identified based on the ninth action item D₉ “reserved hotel” and the tenth action item D₁₀ “booked flight,” generating a travel behavioral insight category. A fifth action cluster 412 can be identified based on the eleventh action item D₁₁ “bought Christmas lights;” the twelfth action item D₁₂ “bought wall painting;” and the thirteenth action item D₁₃ “posted or commented about merry Christmas and Happy New Year,” generating a home or holiday behavioral insight category. A sixth action cluster 414 can be identified based on the sixteenth action item D₁₆ “searched for earthquake” and the seventeenth action item D₁₇ “donated for earthquake fund,” generating a philanthropy or geography behavioral insight category.

Turning to FIG. 5, a system 500 can include the activity timeline 118 which, like the activity timeline 118 of FIG. 4, can be used by the behavioral insight categories generator 120 to generate behavioral insight categories. Moreover, the system 500 depicted in FIG. 5 can generate data to be presented at a GUI 502 as a timeline view 504.

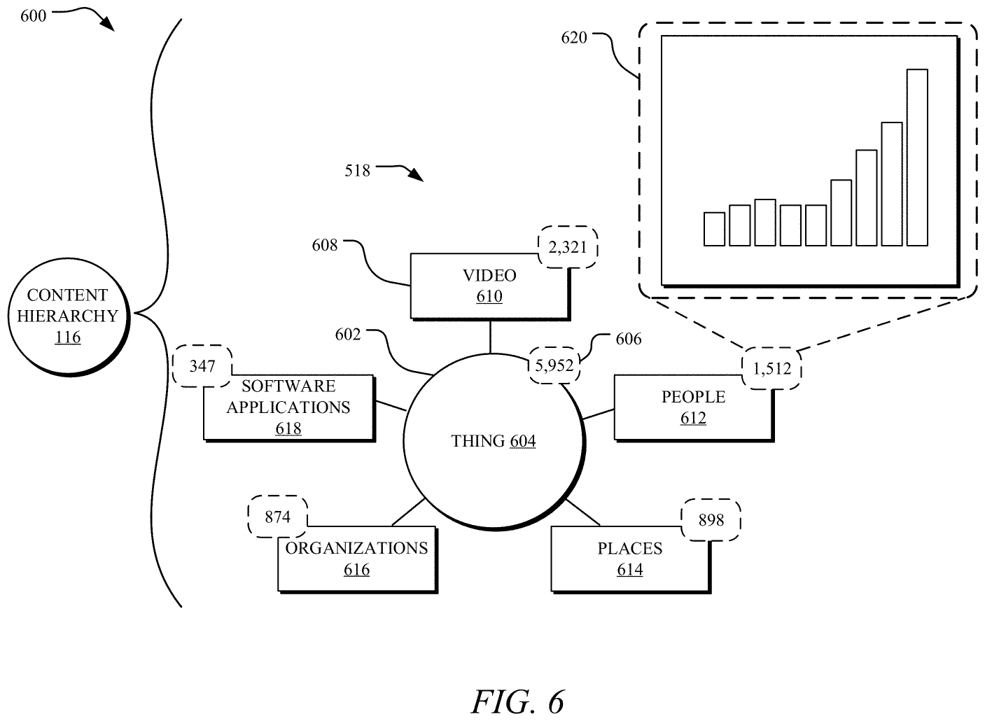

The behavioral insight categories generator 120 can generate behavioral insight categories by detecting activity patterns 402 from the activity timeline 118 generated from the categorized user data. The behavioral insight categories generator 120 can detect an action item recurrence 506, such as an action item recurrence amount, an action item frequency, an action item periodicity, and/or a total number of occurrences. For instance, the action item recurrence 506 can include the fourteenth action item D₁₄ “searched reviews for ‘The Escape Room’ and the fifteenth action item D₁₅ “watched trailer for ‘The Escape Room,’ which can be associated with the activity timeline 118 at a first time (e.g., relatively early in the year). The action item recurrence 506 can also be based on the eighteenth action item D₁₈ “searched reviews for ‘Five Feet Apart;’ the fourth account action AA₄ “subscribed to HBO®;” the nineteenth action item D₁₉ “searched for “Maiden;’ and/or the twenty-first action item D₂₁ “searched reviews for “Ford vs Ferrari.” In some instances, the multi-data source personality profile generator 110 can identify one or more activity patterns 402, such as an action frequency, an action recurrence amount, an action periodicity, an action-reaction occurrence, a total number of action occurrences, or an action cluster. Any of the behavioral insight categories discussed herein (e.g., regarding FIG. 6) can be generated based on identifying an activity pattern 402. Behavior metrics 124 can also be generated based on the timeline 118 and/or the activity patterns, such as sleep and wake up times, time spent at home or work (e.g., without digital activity) percentages, most probable times for shopping, travel and commute distances, most used Internet-of-Things (IoT) service(s), pattern in any activity with special events, vacation and commute behaviors, video watching behavior, content preferences, video games and application usage, job searches and other search patterns, and the like. Moreover, behavioral insight categories and/or behavior metrics 124 can be generated based on daily step metrics generated by a daily steps tracker 508 (e.g., which can be displayed at the GUI 502 simultaneously with the activity timeline 118 in the timeline view 504). Moreover, the multi-data source personality profile generator 110 can generate a summary 510 and/or cause the summary 510 to be presented as part of the timeline view 504. For instance, the summary 510 can include an aggregation of behavior metrics 124 generated from the behavioral insight categories and the categorized user data. By way of example, the summary depicted in FIG. 5 may indicate “high interest/enthusiasm for sports, movies, fitness, and travel;” “medium interest in holidays;” “high willingness to make purchase for home;” “medium or low willingness to click on ads;” “high willingness to subscribe to digital media;” “medium level of social media participation;” and the like.

As noted above, the timeline view 504 representing the activity timeline can be presented using the GUI 502 (e.g., of a computing device 1102 as discussed regarding FIG. 11). For instance, an action item can be represented by an action item indicator 512 having one or more visualizations representing various characteristics, categories, tags (e.g., associations with content-based bin(s) 114), weights, scales, activity patterns, behavioral insight categories, and the like. For instance, a first visualization 514 can include a color coding indicating an action bin 152 association (e.g., search-related action items, purchase-related action items, post-related action items, watched-related action items, etc.). A second visualization 516 can indicate the evidence confidence rating 208 (e.g., as a visual length dimension). Moreover, the summary 510 and/or the daily steps tracker 508 can be presented as visualizations (e.g., selectable for viewing additional information. Moreover, the system 500 can receive a user input (e.g., from an insurance agent or data privacy advisor) selecting between the timeline view 504 and a content view 518 for viewing at the GUI 502. The system 500 can include a sixth visualization 520 including a text description of the action item and/or the content item associated with the action item. The content view 518 is a visualization of the content hierarchy 116, as discussed in greater detail below regarding FIG. 6.

For instance, turning to FIG. 6, a system 600 can include the content hierarchy 116 generated from the user data 104 and/or categorized user data. The content hierarchy 116 can be generated based on various action items represented by the user data 104 (e.g., based on search data). The content hierarchy 116 can be a data structure that organizes content items (things or nouns, actions or verbs, etc.) of the action items in the user data 104 into hierarchical categories and sub-categories according to a semantic analysis of the user data 104. The content hierarchy 116 can also organize the content items of the action items based on a total count number for the content items in the user data 104.

In some examples, the content hierarchy 116 can include a first content hierarchy level 602 that can be a top or a highest hierarchy level. As depicted in FIG. 6, the first content hierarchy level can include a first behavioral insight category such as a “thing” behavioral insight category 604. The thing behavioral insight category 604 can include every “thing” item included in the user data 104 and/or a total count number 606 of content items in the thing behavioral insight category 604 (e.g., 5,952). The content hierarchy 116 can include one or more behavioral insight categories in a second content hierarchy level 608 below the first content hierarchy level 602. For instance, the second content hierarchy level 608 can include a second behavioral insight category such as a “movies/tv” behavioral insight category 610; a third behavioral insight category such as a “people” behavioral insight category 612; a fourth behavioral insight category such as a “places” behavioral insight category 614; a fifth behavioral insight category such as a “organizations” behavioral insight category 616; and/or a sixth behavioral insight category such as a “software applications” behavioral insight category 618. In some instances, the thing behavioral insight category 604 can be determined based on the total count number 606 of occurrences of the content item in the user data 104. The multi-data source personality profile generator 110 can determine, for instance, that the total count number 606 of occurrences of “things” is greater than a predetermined threshold and, as such, the thing behavioral insight category 604 is generated. Similarly, a total count number for the second behavioral insight category 610, the third behavioral insight category 612, the fourth behavioral insight category 614, the fifth behavioral insight category 616, and/or the sixth behavioral insight category 618 can be greater than the predetermined threshold and, as such, may these behavioral insight categories may also be generated and/or determined as part of the personality profile generating process performed by the multi-data source personality profile generator 110. Moreover, the content hierarchy 116 can include a third content hierarchy level 620, a fourth content hierarchy level, and/or any number of content hierarchy levels to categorize and organize the content items represented by the use data 104 into the content hierarchy 116. As shown in FIG. 3, the third content hierarchy level 620 can be a sub-level or sub-category of the people behavioral insight category 612 of the second content hierarchy level 608. For instance, the third content hierarchy level 620 can include one or more content items being a sub-category of the people behavioral insight category (e.g., and/or with corresponding total count numbers). Non-limiting examples of such sub-categories may include as “actor,” “actress,” “film,” “singer,” “director,” “politician,” “president,” “minister,” and “cricketer.” The content items in the third content hierarchy level 620 can also include and/or be arranged according to the corresponding total count numbers (e.g., with the “actor” type of people having a highest total count number and “cricketeer” type of people having a lowest total count number).

In some instances, the content hierarchy 116 can be presented as the content view 518 at the GUI 502. For example, a selectable GUI element presented at the 502 may cause the system 700 to toggle between presenting the content view 518 and the timeline view 504. The content hierarchy 116, in addition or alternatively to the activity timeline 118, can be a data structure generated by the multi-data source personality profile generator 110 to represent the user data 104, received from the different digital source(s) 106, in a standardized or common format. The content hierarchy 116 can be used by downstream analytics of the multi-data source personality profile generator 110 (e.g., by the personality profile generation process 122) to determine the behavioral insight categories and/or the behavior metrics 124.

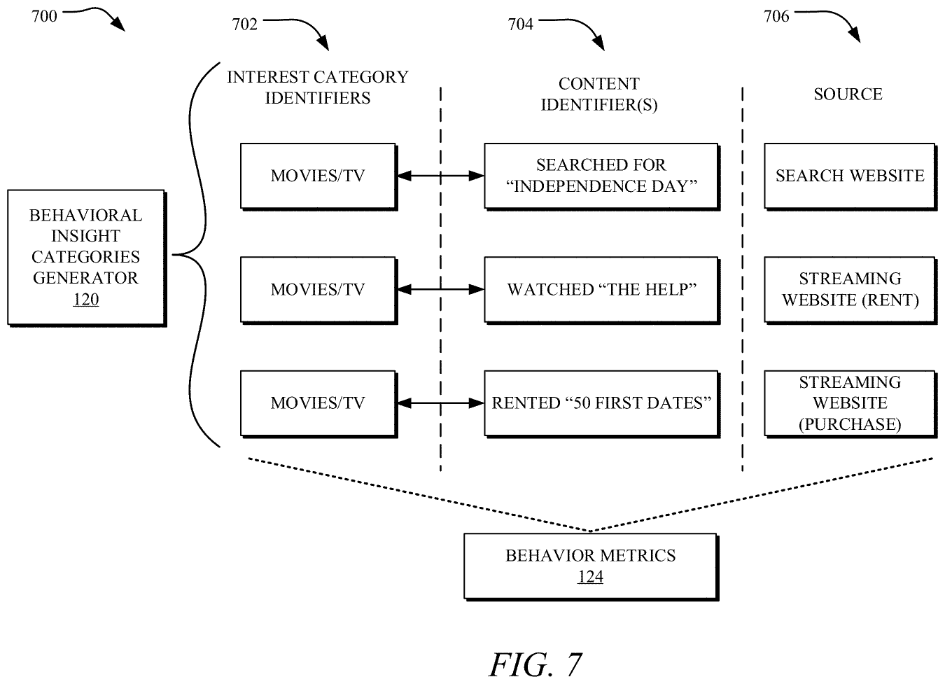

Turning to FIG. 7, a system 700 for generating the personality profile 102 from the one or more digital sources 106 can include the behavioral insight categories generator 120 for generating the behavior metrics 124. Using the techniques discussed herein, the system 700 can determine the behavioral insight categories by generating the activity timeline 118 and identifying the activity patterns (e.g., based on the associations to the content-based bin(s) 114). The system 700 can further generate or determine one or more interest category identifiers 702 corresponding to the behavioral insight categories, and associate the one or more interest category identifiers 702 with the action items. The system 700 can also generate or determine one or more content identifier(s) 704 indicating the content items determined by the content hierarchy 116 and/or the actions indicated by the activity bin 152 associated with the action items for procuring the content. The system 700 can also identify one or more sources 706 of the action items. The behavior metrics 124 can be based on the interest category identifiers 702, the content identifiers 704, and/or the sources 706.

For example, the behavioral insight categories generator 120 can determine, for a first action item, a first behavioral insight category identifier being a “movies/tv” identifier. The behavioral insight categories generator 120 can determine a first content identifier for the first action item being “searched for ‘Independence Day,’” and a first source being a search website (e.g., Google®). For a second action item, the behavioral insight categories generator 120 can determine a second behavioral insight category identifier is the “movies/tv” identifier; a second content identifier is a “watched ‘The Help”’ identifier; and a second source is a streaming website (e.g., Netflix) rental. For a third action item, the behavioral insight categories generator 120 can determine a third behavioral insight category identifier is the “movies/tv” identifier; a third content identifier is a “rented ‘50 First Dates’” identifier; and a third source is a streaming website (e.g., Amazon® Prime®) purchase.

The system 700 can determine the one or more behavior metrics 124 based on the one or more interest category identifiers 702, the content identifier(s) 704, and/or the sources 706 associated with the action items of the user data 104. For the example depicted in FIG. 7, the multi-data source personality profile generator 110 (e.g., as part of the personality profile generation process 122) can determine one or more behavior metrics 124 indicating a high interest in movies and tv, indicating a high frequency of watching/buying movies and tv; indicating an openness to different genres (e.g., which corresponds to a high level of openness/adaptability of new experiences); and/or a high willingness to use multiple, different streaming platforms. Various other behavior metrics 124 (e.g., based on the one or more interest category identifiers 702 such as the “movies/tv” identifier) can be determined as well.

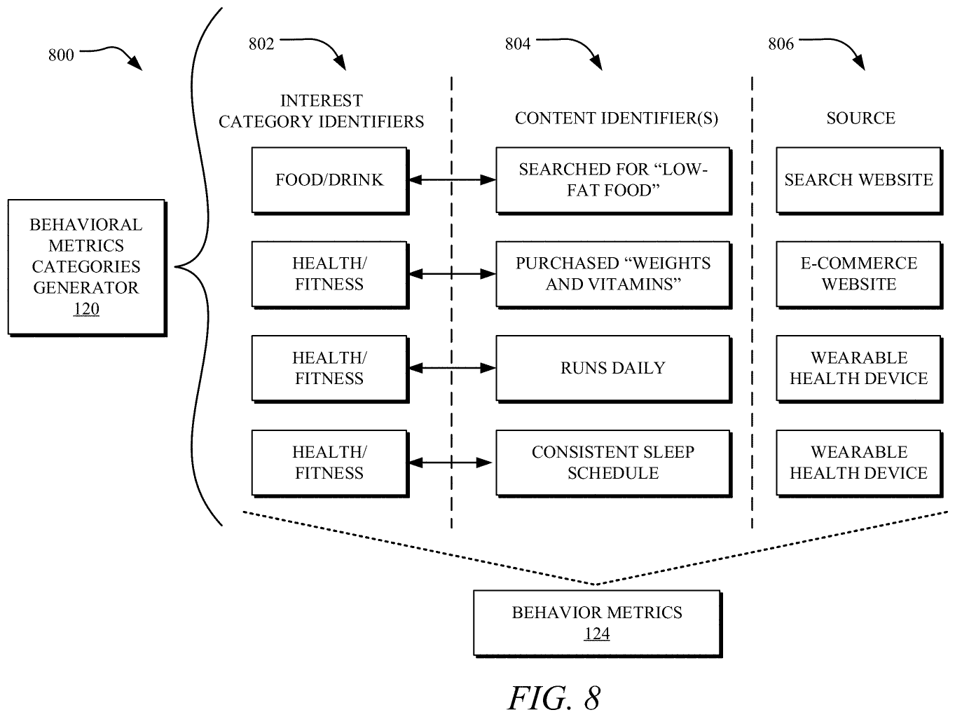

Turning to FIG. 8, a system 800 can generate the behavior metrics 124 by analyzing the categorized user data to identify one or more interest category identifiers 702 and/or content identifier(s) 704 (e.g., using similar or identical techniques as the system 700 discussed above regarding FIG. 7). For instance, the multi-data source personality profile generator 110 (e.g., as part of the personality profile generation process 122) can determine that a fourth action item corresponds to a fourth behavioral insight category identifier being a “food/drink” identifier, a fourth content identifier being a “searched for ‘low-fat food,’” and/or a source being a search website. Moreover a fifth action item can correspond to a fifth behavioral insight category identifier being a “health/fitness” identifier, a fifth content identifier being “purchased ‘weights and vitamins,’ and a fifth source being an e-commerce website. A sixth action item can correspond to a sixth interest category identifier being a “health/fitness” identifier, a sixth content identifier being a “runs daily” identifier, and a sixth source being a wearable device. Finally, a seventh action item can correspond to a seventh behavioral insight category identifier being a “health/fitness” identifier, a seventh content identifier being a “consistent sleep schedule” identifier, and a seventh source being the wearable health device.

The system 800 can determine, based on the interest category identifiers 802, the content identifiers 804, and/or the sources 806, that the fourth through eighth action items indicate a behavior metric 124 of highly healthy or high interest in maintaining health. The multi-data source personality profile generator 110 can aggregate the multiple action items from across multiple different content-based bins 114 to generate the interest category identifiers 802 and/or the behavior metrics 124. The system 800 can determine the behavior metrics 124 by detecting relations to common concepts or ideas, or to predefined behavior metric templates (e.g., including one or more threshold values and/or (Y/N) data structures). For instance, the personality profile generation process 122 can determine that the fourth through eight content identifiers of the fourth through eight action items relate to health/fitness (e.g., and/or a positive inclination towards health/fitness) and generate the behavior metrics 124 based on this determination.

It should be understood that the various interest category identifiers 702 assessed or aggregated to determine the behavior metrics 124 can be based on action items and/or tags spanning across different content-based bin(s) 114 (e.g., a first action item associated with the purchases bin 150, a second action item associated with the fitness bin 154, etc.). Moreover, a single action item can be associated with multiple content-based bin(s) 114 and/or generate multiple interest category identifiers 702 and/or content identifiers 704. Additionally, a particular behavior metrics 124 can be generated based on action items corresponding to multiple, different interest category identifiers 702, having multiple, different content identifiers 704, and/or multiple different sources 706 (e.g., as depicted in FIG. 8). The system 800 can determine a combination of correlations between various action items, corresponding content-based bin 114 associations, and the interest category identifiers 802, the content identifiers 804, and/or the sources 806, which may result in outputting the behavior metrics 124. For example, the system 800 may utilize one or more pattern recognition algorithms to identify particular behavior metrics 124 by correlating the content identifiers 804 through one or more predictive regression algorithms, and using a process of model generation, regression, validation, and alteration repeated until a determined error of a behavior metric prediction model falls below a threshold value (e.g., by comparing test run results to predefined test data or historical data). The system 800 may determine the behavioral insight categories (e.g., the interest category identifiers 702) and/or the behavior metrics 124 by using a multilayer perceptron (MLP) machine-learning system and a training data set of predetermined behavioral insight categories, predetermined behavior metrics 124 and/or historical user data (e.g., on which the predetermined insight categories and/or predetermined behavior metrics were based). In this manner, the multi-data source personality profile generator 110 can utilize techniques (e.g., the one or more pattern recognition algorithms) to generate the behavior metrics 124.

In some examples, the one or more interest category identifiers 702 corresponding to behavioral insight categories can include one or more of art, culture, entertainment, automobiles, vehicles, news, family, parenting, sports, recreation, hobbies, interests, geography, travel, home, garden, health, fitness, law, government, politics, food, drink, pets, style, fashion, cosmetics, personal care, history, events, human activities, philosophy, finance, education, careers, business, industrial, real estate, religion, spirituality, science, shopping, society, technology, computing, kids, combinations thereof, and the like. The behavior metric 124 can be generated for a particular behavioral insight category upon determining that sufficient evidence to support the behavior metrics 124 exists (e.g., based on supervised machine learning statistical analysis). Once one or more behavior metrics 124 are generated to a sufficient degree of confidence indicating an affinity or aversion, or another relationship, of the specific individual to the behavioral insight categories. The behavior metrics 124 can be used to generate or define the behavioral dimensions 126 of the personality profile 102, as discussed below.

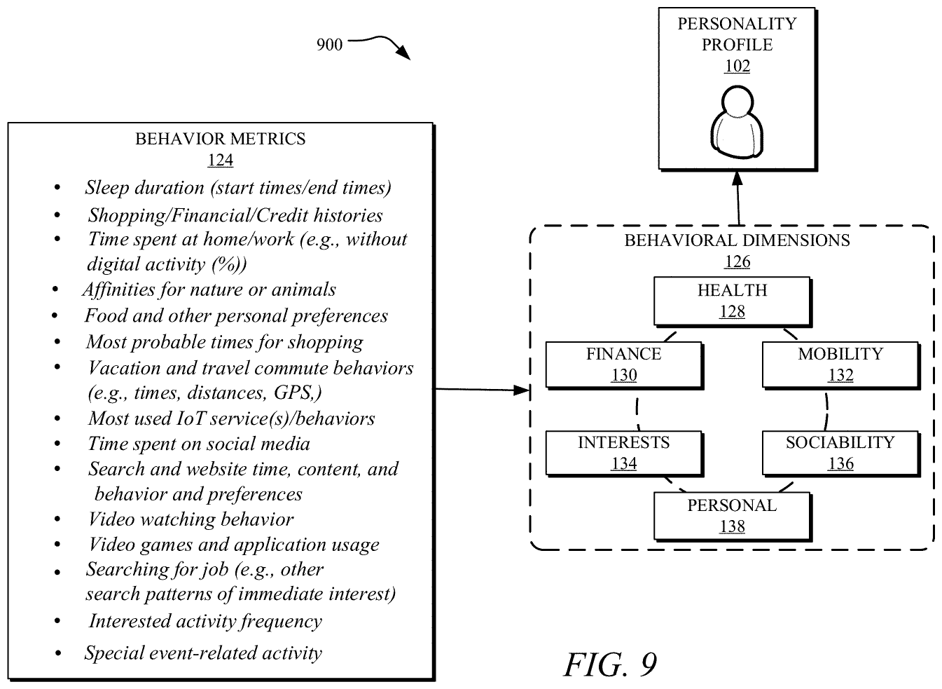

FIG. 9 illustrates an example system 900 for generating or defining the behavioral dimensions 126 based on the behavior metrics 124 (e.g., which may form a portion of any of the systems 100-800 previously discussed). For instance, the multi-data source personality profile generator 110 may include six predefined behavioral dimensions 126, and match the behavior metrics 124 to one or more of the behavioral dimensions 126. The behavioral dimensions 126 can correspond to components of a risk profile and/or degrees of risk for a risk assessment. By way of example, the sleep duration start/end times behavior metric can define, correspond to, or map to the personal identity dimension 138 and/or the health dimension 128. The time spent at home or work (e.g., without digital activity) can map to the mobility dimension 132, the health dimension 128, the personal identity dimension 138, and/or the sociability dimension 136 (e.g., depending on whether other people are at home or work). A high interest in a movie or tv show, a particular type of movie or tv show, and/or any content item of the content hierarchy 116 can map to the interests dimension 134. A shopping, financial, or credit history-related behavior metric 124 can map to the finance dimension 130. Any behavior metrics 124 (e.g., and/or behavioral insight categories) discussed throughout this disclosure can be mapped to or otherwise used to define the behavioral dimensions 126. A machine-learning algorithm may use the behavioral dimensions 126 to assess the behavioral insight categories, the content hierarchy 116, and/or the activity timeline 118 to answer one or more personality questions, such as “how healthy is this person?” (e.g., the health dimension 128, which may indicate health risk); “how financially stable is this person?” (e.g., the finance dimension 130, which may indicate financial risk); “what is a mobility of this person?” (e.g., the mobility dimension 132, which may indicate a driving risk); “what things/activities does this person like, buy, go to, or do?” (e.g., the interests dimension 134, which may indicate consumer traits); “what is the social network of this person?” (e.g., the sociability dimension 136, which may indicate social risk or other correlations); and/or “who is this person and what/where is the sensitive data for this person?” (e.g., the personal identity dimension 138, which may indicate a PII risk, a family status, and/or demographics).

In some examples, the health dimension 128 can be generated based on one or more behavior metrics 124 indicating physical health, mental health, eating habits, and/or fitness. For instance, behavior metrics 124 influencing the physical health component of the health dimension 128 can include a search, like or post of diseases or symptoms, a subscription to a page or group, a health or wellness appointment, a genetic risk calculation, a genetic test, alcohol or drug abuse, medicine purchase, health application usage, and the like. The health dimension 128 behavior metrics 124 influencing the mental health component can include internet and/or mobile addition, sleeping habits, shopping addiction, searches, likes, and posts, subscriptions to groups and/or pages, and the like. The behavior metrics 124 influencing the physical eating habits component of the health dimension 128 can include food orders, restaurant visits, diet plan searches, diet plan subscription and/or page follows, food purchases, organic purchase, search for food, cuisine, or recipe terms, diet plan searches, food purchases on a food delivery service, and the like. The health dimension 128 behavior metrics 124 influencing the fitness component can include mobility data from fitness applications and/or computing devices (e.g., discussed below regarding FIG. 11), gym memberships, searches/purchases of equipment, exercise videos, hiking or exercise activity groups, posts on social media, and the like.

Moreover, the finance dimension 130 can be generated based on one or more behavior metrics 124 indicating online purchases, retail purchases, and/or an income estimate. For instance, the behavior metrics 124 influencing the online purchases component of the finance dimension 130 can include purchase at large retail sites (e.g., Amazon®, eBay®, PayPal, and the like), apparel purchase, electronics purchase, online marketplace purchase, and/or food orders (e.g., via mobile food ordering applications). The behavior metrics 124 influencing the retail purchase component of the finance dimension 130 can include store visits and/or store receipts (e.g., based on credit card statements, bank statements, and/or personal finance management applications). The behavior metrics 124 influencing the income estimate component of the finance dimension 130 can include savings account data, checking account data (e.g., including monthly credits and debits), education level, household composition, job description, earnings-to-debt ratio, and the like.

In some instances, the mobility dimension 132 can be generated based on behavior metrics 124 indicating a daily schedule and/or travel. For instance, the behavior metrics 124 influencing the daily schedule component of the mobility dimension 132 can include one or more of a travel time, an idle time, a schedule for a visit, location hopping, day mobility behavior and night mobility behavior, traffic courses, and the like. Additionally, the behavior metrics 124 influencing the travel component of the mobility dimension 132 can include one or more of a vacation plan, a tourist destination, service-based housing, an extended drive, and/or a frequency of visits. Moreover, the system 1000 can determine the mobility dimension 132 based on searches for vacation gear, flight tickets, rental bookings, and/or searches for rental places.

In some examples, the interests dimension 134 can be generated based on google searches, social media posts, page likes, comments, and subscriptions, purchases, and activities (e.g., games). For instance, the interests dimension 134 can be based on the content identifier(s) 704 of the content hierarchy 116. The interests dimension 134 can indicate consumer traits/interests related to one or more of art, culture, entertainment, automobiles, vehicles, news, family, parenting, sports, recreation, hobbies, interests, geography, travel, home, garden, health, fitness, law, government, politics, food, drink, pets, style, fashion, cosmetics, personal care, history, events, human activities, philosophy, finance, education, careers, business, industrial, real estate, religion, spirituality, science, shopping, society, technology, computing, kids, combinations thereof, and the like.

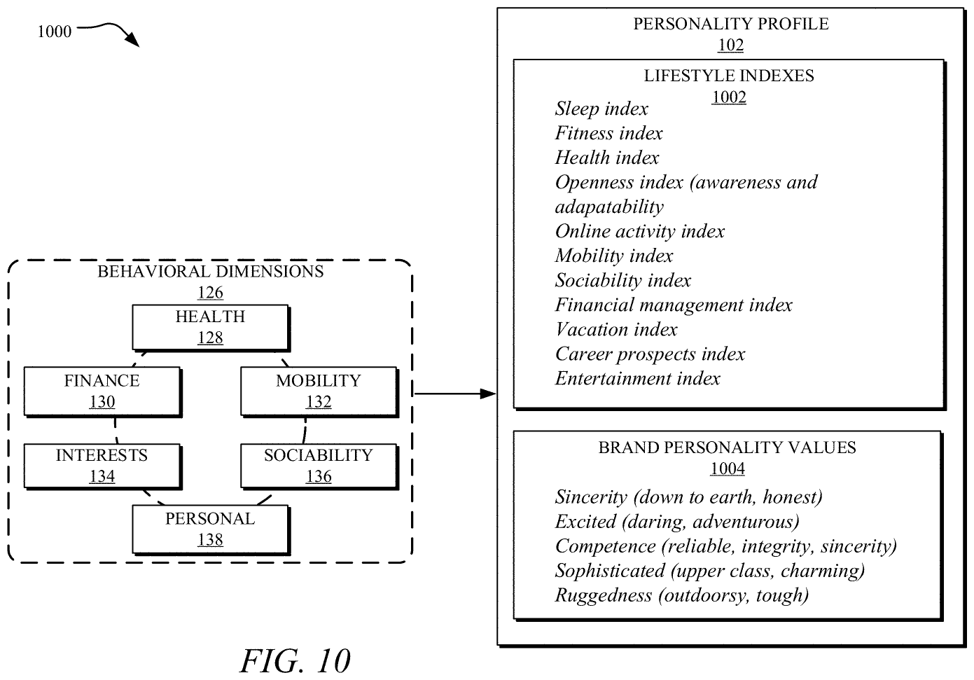

FIG. 10 illustrates an example system 1000 for generating the personality profile 102 including one or more lifestyle index values 1002 and/or one or more brand personality values 1004.

In some instances, the lifestyle index values 1002 can include a variety of indexes with a score, label, or value on a scale or in a range (e.g., Y/N or between 1 and 10, 1 and 100, etc.) associated with a particular lifestyle component. The supervised machine-learning systems can calculate the lifestyle index values 1002 and/or brand personality values 1004 based on analyzing the behavioral dimensions 126. For instance, the system 1000 can generate one or more values corresponding to a sleep index, a fitness index, a health index, an openness index (e.g., indicating awareness/adaptability to new experiences), an online activity index, a mobility index, a sociability index, a financial management index, a vacation index, a career prosects index, an entertainment index, combinations thereof, and the like.

Moreover, the multi-data source personality profile generator 110 can use the behavioral dimensions 126 to generate the brand personality values 1004, which can include one or more scores indicating a sincerity value (e.g., indicating down to earth and/or honest); an excited value (e.g., indicating daringness and/or adventurousness); a competence value (e.g., indicating reliability, integrity, and/or sincerity); a sophistication value (e.g., indicating an upper/middle/lower class status, education level, and/or charming); and/or a ruggedness value The personality profile 102 can be formed of the lifestyle index values 1002 and the brand personality values 1004, as well as the other data structures and/or interfaces discussed herein (e.g., the categorized user data, the content hierarchy 116, the activity timeline 118, the content view 518, and/or the timeline view 504). As noted above the personality profile 102 can be used to generate a risk assessment for insurance policy pricing; a data privacy assessment for a data privacy service; and/or or a product recommendation for a commerce website.

FIG. 11 illustrates an example network environment 1100 for generating the personality profile 102 based on the user data 104 from a variety of digital sources 106, using the systems 100-1000 discussed herein. The example network environment 1100 includes the one or more network(s) 146 which can be a cellular network such as a 3rd Generation Partnership Project (3GPP) network, a third generation (3G) network, a fourth generation (4G) network, a fifth generation (5G) network, a Long-Term Evolution (LTE), an LTE Advanced Network, a Global System for Mobile Communications (GSM) network, a Universal Mobile Telecommunications System (UMTS) network, and the like. Moreover, the network(s) 146 can include any type of network, such as the Internet, an intranet, a Virtual Private Network (VPN), a Voice over Internet Protocol (VoIP) network, a wireless network (e.g., Bluetooth), a cellular network, a satellite network, combinations thereof, etc. The network(s) 146 provide access to and interactions with systems providing input to the multi-data source personality profile generator 110, such as the one or more digital sources 106. The network(s) 146 can include communications network components such as, but not limited to gateways routers, servers, and registrars, which enable communication across the network(s) 146. In one implementation, the communications network components include multiple ingress/egress routers, which may have one or more ports, in communication with the network(s) 146. Communication via any of the networks can be wired, wireless, or any combination thereof.

The network environment 1100 also include at least one server device 108 hosting software, application(s), websites, and the like for receiving input data and analyzing the input data to generate the personality profile 102. The multi-data source personality profile generator 110 can receive inputs from various computing devices and transform the received input data into other unique types of data. The server(s) 108 may be a single server, a plurality of servers with each such server being a physical server or a virtual machine, or a collection of both physical servers and virtual machines. In another implementation, a cloud hosts one or more components of the systems 100-1000. The server(s) 108 may represent an instance among large instances of application servers in a cloud computing environment, a data center, or other computing environment. The server(s) 108 can access data stored at one or more database(s) (e.g., including any of the values or identifiers discussed herein). The systems 100-1000, the server(s) 108, and/or other resources connected to the network(s) 146 may access one or more other servers to access other websites, applications, web services interfaces, GUIs, storage devices, APIs, computing devices, or the like to perform the techniques discussed herein. The server(s) can include one or more computing device(s) 1102, as discussed in greater detail below.

For instance, the network environment 1100 can include the one or more computing device(s) 1102 for executing the multi-data source personality profile generator 110 and/or generating the personality profile 102. In one implementation, the one or more computing device(s) 1102 include the one or more server device(s) 108 executing the multi-data source personality profile generator 110 as a software application and/or a module or algorithmic component of software.

In some instances, the computing device(s) 1102 can include a computer, a personal computer, a desktop computer, a laptop computer, a terminal, a workstation, a server device, a cellular or mobile phone, a mobile device, a smart mobile device a tablet, a wearable device (e.g., a smart watch, smart glasses, a smart epidermal device, etc.) a multimedia console, a television, an Internet-of-Things (IoT) device, a smart home device, a medical device, a virtual reality (VR) or augmented reality (AR) device, a vehicle (e.g., a smart bicycle, an automobile computer, etc.), and/or the like. The computing device(s) 1102 may be integrated with, form a part of, or otherwise be associated with the systems 100-1000. It will be appreciated that specific implementations of these devices may be of differing possible specific computing architectures not all of which are specifically discussed herein but will be understood by those of ordinary skill in the art.

The computing device 1102 may be a computing system capable of executing a computer program product to execute a computer process. Data and program files may be input to the computing device 1102, which reads the files and executes the programs therein. Some of the elements of the computing device 1102 include one or more hardware processors 1104, one or more memory devices 1106, and/or one or more ports, such as input/output (IO) port(s) 1108 and communication port(s) 1110. Additionally, other elements that will be recognized by those skilled in the art may be included in the computing device 1102 but are not explicitly depicted in FIG. 11 or discussed further herein. Various elements of the computing device 1102 may communicate with one another by way of the communication port(s) 1110 and/or one or more communication buses, point-to-point communication paths, or other communication means.

The processor 1104 may include, for example, a central processing unit (CPU), a microprocessor, a microcontroller, a digital signal processor (DSP), and/or one or more internal levels of cache. There may be one or more processors 1104, such that the processor 1104 comprises a single central-processing unit, or a plurality of processing units capable of executing instructions and performing operations in parallel with each other, commonly referred to as a parallel processing environment.

The computing device 1102 may be a conventional computer, a distributed computer, or any other type of computer, such as one or more external computers made available via a cloud computing architecture. The presently described technology is optionally implemented in software stored on the data storage device(s) such as the memory device(s) 1106, and/or communicated via one or more of the I/O port(s) 1108 and the communication port(s) 1110, thereby transforming the computing device 1102 in FIG. 11 to a special purpose machine for implementing the operations described herein and generating the personality profile 102. Moreover, the computing device 1102, as implemented in the systems 100-1000, receives various types of input data (e.g., in different data formats) and transforms the input data through the stages of the data flow described herein into new types of data files (e.g., the categorized user data, the content hierarchy 116, and the activity timeline 118,). Moreover, these new data files are transformed further into the behavior metrics 124 the behavioral dimensions 126, the lifestyle index values 1002, and the brand personality values 1004, which enables the computing device 1102 to do something it could not do before—generate the personality profile 102 based on user data 104 from different digital sources 106.

The one or more memory device(s) 1106 may include any non-volatile data storage device capable of storing data generated or employed within the computing device 1102, such as computer executable instructions for performing a computer process, which may include instructions of both application programs and an operating system (OS) that manages the various components of the computing device 1102. The memory device(s) 1106 may include, without limitation, magnetic disk drives, optical disk drives, solid state drives (SSDs), flash drives, and the like. The memory device(s) 1106 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory device(s) 1106 may include volatile memory (e.g., dynamic random-access memory (DRAM), static random-access memory (SRAM), etc.) and/or non-volatile memory (e.g., read-only memory (ROM), flash memory, etc.).

Computer program products containing mechanisms to effectuate the systems and methods in accordance with the presently described technology may reside in the memory device(s) 1106 which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computing device 1102 includes one or more ports, such as the I/O port(s) 1108 and the communication port(s) 1110, for communicating with other computing or network devices. It will be appreciated that the I/O port 1108 and the communication port 1110 may be combined or separate and that more or fewer ports may be included in the computing device 1102.

The I/O port 1108 may be connected to an I/O device, or other device, by which information is input to or output from the computing device 1102. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing device 1102 via the I/O port 1108. Similarly, the output devices may convert electrical signals received from the computing device 1102 via the I/O port 1108 into signals that may be sensed as output by a human, such as sound, light, and/or touch. The input device may be an alphanumeric input device, including alphanumeric and other keys for communicating information and/or command selections to the processor 1104 via the I/O port 1108. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

In one implementation, the communication port 1110 is connected to the network 146 so the computing device 1102 can receive network data useful in executing the methods and systems set out herein as well as transmitting information and network configuration changes determined thereby. Stated differently, the communication port 1110 connects the computing device 1102 to one or more communication interface devices configured to transmit and/or receive information between the computing device 1102 and other devices (e.g., network devices of the network(s) 146) by way of one or more wired or wireless communication networks or connections. Examples of such networks or connections include, without limitation, Universal Serial Bus (USB), Ethernet, Wi-Fi, Bluetooth®, Near Field Communication (NFC), and so on. One or more such communication interface devices may be utilized via the communication port 1110 to communicate with one or more other machines, either directly over a point-to-point communication path, over a wide area network (WAN) (e.g., the Internet), over a local area network (LAN), over a cellular network (e.g., third generation (3G), fourth generation (4G), Long-Term Evolution (LTE), fifth generation (5G), etc.) or over another communication means. Further, the communication port 1110 may communicate with an antenna or other link for electromagnetic signal transmission and/or reception.

In an example the multi-data source personality profile generator 110, the data aggregator 112, the personality profile generation process 122 and/or other software, modules, services, and operations discussed herein may be embodied by instructions stored on the memory devices 1106 and executed by the processor 1104.

The system set forth in FIG. 11 is but one possible example of a computing device 1102 or computer system that may be configured in accordance with aspects of the present disclosure. It will be appreciated that other non-transitory tangible computer-readable storage media storing computer-executable instructions for implementing the presently disclosed technology on a computing system may be utilized. In the present disclosure, the methods disclosed may be implemented as sets of instructions or software readable by the computing device 1102.

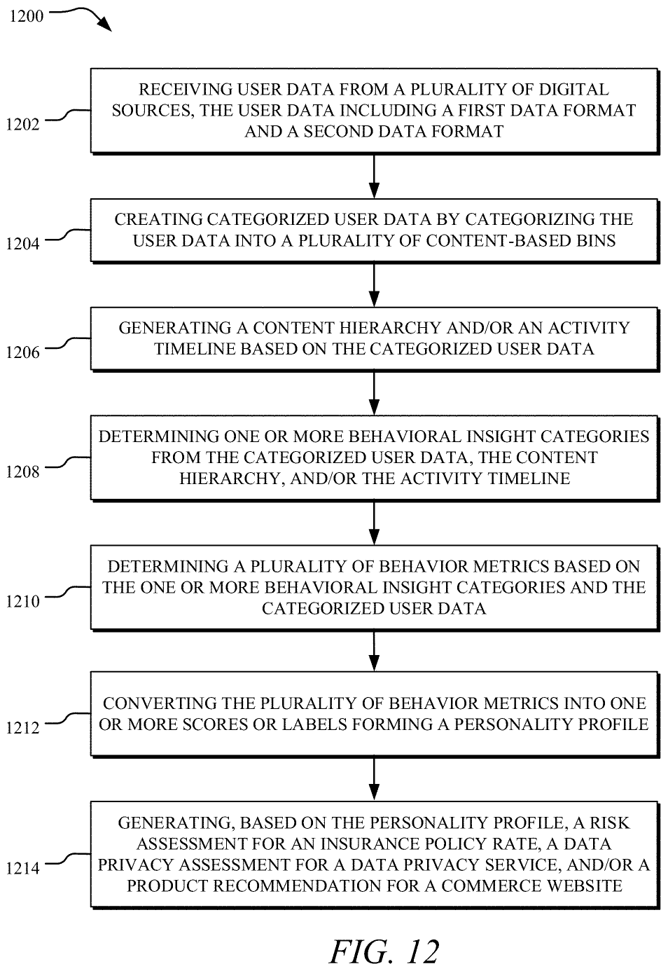

FIG. 12 depicts an example method 1200 for generating the personality profile 102 with the multi-data source personality profile generator 110 using data from different digital sources 106, which can be performed by any of the systems 100-1000 and/or network environment 1100. At operation 1202, the method 1200 receives user data from a plurality of digital sources, the user data including a first data format and a second data format. At operation 1204, the method 1200 creates categorized user data by categorizing the user data into a plurality of content-based bins. At operation 1206, the method 1200 generates a content hierarchy and/or an activity timeline based on the categorized user data. At operation 1208, the method 1200 determines one or more behavioral insight categories from the categorized user data, the content hierarchy, and/or the activity timeline. At operation 1210, the method 1200 determines a plurality of behavior metrics based on the one or more behavioral insight categories and the categorized user data. At operation 1212, the method 1200 converts the plurality of behavior metrics into one or more scores forming a personality profile. At operation 1214, the method 1200 generates, based on the personality profile, a risk assessment for an insurance policy rate, a data privacy assessment for a data privacy service, and/or a product recommendation for a commerce website.

It is to be understood that the specific order or hierarchy of operations in the methods depicted in FIG. 12 and throughout this disclosure are instances of example approaches and can be rearranged while remaining within the disclosed subject matter. For instance, any of the operations depicted in FIG. 12 may be omitted, repeated, performed in parallel, performed in a different order, and/or combined with any other of the operations depicted in FIG. 12 or discussed herein.

Furthermore, any term of degree such as, but not limited to, “substantially,” as used in the description and the appended claims, should be understood to include an exact, or a similar, but not exact configuration. Similarly, the terms “about” or “approximately,” as used in the description and the appended claims, should be understood to include the recited values or a value that is three times greater or one third of the recited values. For example, about 3 mm includes all values from 1 mm to 9 mm, and approximately 50 degrees includes all values from 16.6 degrees to 150 degrees.

Lastly, the terms “or” and “and/or,” as used herein, are to be interpreted as inclusive or meaning any one or any combination. Therefore, “A, B, or C” or “A, B, and/or C” mean any of the following: “A,” “B,” or “C”; “A and B”; “A and C”; “B and C”; “A, B and C.” An exception to this definition will occur only when a combination of elements, functions, steps or acts are in some way inherently mutually exclusive.

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular implementations. Functionality may be separated or combined differently in various implementations of the disclosure or described with different terminology. These and other variations, modifications, additions, and improvements may fall within the scope of the disclosure as defined in the claims that follow.

What is claimed is:

1. A method for behavior assessment for an individual, the method comprising:
obtaining user data for the individual from one or more digital sources;
creating categorized user data by transforming the user data into a platform independent format, the categorized user data being associated with a plurality of content-based bins;
determining one or more behavioral insight categories from the categorized user data;
determining a plurality of behavioral metrics based on the one or more behavioral insight categories and the categorized user data;
forming a personality profile for the individual by converting the plurality of behavioral metrics into one or more scores; and
generating a risk assessment for the individual based on the personality profile.

2. The method of claim 1, further comprising:
generating an activity timeline based on the categorized user data;
determining an activity pattern from the activity timeline; and
determining the one or more behavioral insight categories based on the activity pattern.

3. The method of claim 2, wherein the activity pattern comprises at least one of:
an action frequency;
an action recurrence amount;
an action periodicity;
an action-reaction occurrence;
a total number of action occurrences; or
an action cluster.

4. The method of claim 3, further comprising:
generating a content hierarchy from the categorized user data;
determining a first behavioral insight category of the one or more behavioral insight categories using a first content hierarchy level of the content hierarchy in response to the first behavioral insight category having a first number of occurrences greater than a predetermined category threshold; and
determining a second behavioral insight category of the one or more behavioral insight categories using a second content hierarchy level of the content hierarchy in response to the second behavioral insight category having a second number of occurrences greater than the predetermined category threshold.

5. The method of claim 4, further comprising receiving an input selecting a timeline view representing the activity timeline or a content view representing the content hierarchy.

6. The method of claim 1, wherein the one or more digital sources comprise:
a first type of digital source;
a second type of digital source that is different than the first type of digital source; and
a third type of digital source that is different than the first type of digital source and the second type of digital source.

7. The method of claim 6, wherein:
the first type of digital source provides the user data in a first data format;
the second type of digital source provides the user data in a second data format that is different than the first data format; and
the third type of digital source provides the user data in a third data format that is different than the first data format and the second data format.

8. The method of claim 7, wherein the one or more digital sources are at least one of a social media application, a search application, an e-commerce application, a food ordering application, a credit card service, a bank record, or a wearable device application.

9. A system for behavior assessment for an individual, the system comprising:
at least one processor configured to:
receive, from a first digital source, first user data for the individual having a first data format;
receive, from a second digital source, second user data for the individual having a second data format that is different from the first data format;
create categorized user data by categorizing the first user data and the second user data into a plurality of content-based bins;
determine one or more behavioral metrics from the categorized user data;
determine a plurality of behavioral dimensions based on the one or more behavioral metrics and the categorized user data;
generate a personality profile for the individual by converting the plurality of behavioral dimensions into one or more scores; and
generate for the individual, based on the personality profile, one or more of:
a risk assessment;
a data privacy assessment for a data privacy service; or
a product recommendation for a commerce website.

10. The system of claim 9, wherein the plurality of content-based bins include two or more of:
a location bin;
a purchases bin;
an activity bin;
a fitness bin;
a social network bin; or
a personally identifiable information bin.

11. The system of claim 10, wherein the at least one processor is further configured to:
determine a plurality of content identifiers associated with a plurality of action items associated with the plurality of content-based bins;
determine a plurality of interest category identifiers associated with the plurality of action items in the plurality of content-based bins; and
determine one or more behavioral insight categories from the categorized user data by using the plurality of interest category identifiers across different content-based bins, the one or more behavioral metrics being based on the one or more behavioral insight categories.

12. The system of claim 11, wherein the one or more behavioral insight categories are determined using a multilayer perceptron (MLP) machine-learning system and a training data set of predetermined behavioral insight categories.

13. The system of claim 11, wherein:
the plurality of content identifiers indicate a plurality of actions associated with the plurality of action items; and
the plurality of interest category identifiers indicate types of interests associated with the plurality of action items.

14. The system of claim 13, wherein the plurality of actions include at least one of a search for a title associated with a genre, a search for a type of food, a purchase of a consumer good, a purchase of digital media, joining a digital media service, joining a health service, or a performing physical activity.

15. The system of claim 9, wherein creating the categorized user data includes generating a plurality of category tags associated with a plurality of action items represented by the first user data and the second user data.

16. One or more tangible non-transitory computer-readable storage media storing computer-executable instructions for performing a computer process on a computing system, the computer process comprising:
creating categorized user data by categorizing user data for the individual from one or more digital sources into a plurality of content-based bins;
generating an activity timeline representing the categorized user data;
generating a content hierarchy representing the categorized user data;
determining one or more behavioral insight categories from the categorized user data using the activity timeline and the content hierarchy;
determining a plurality of behavior metrics based on the one or more behavioral insight categories and the categorized user data;
converting the plurality of behavior metrics into a personality profile for the individual; and
generating a risk assessment for the individual based on the personality profile.

17. The one or more tangible non-transitory computer-readable storage media of claim 16, wherein converting the plurality of behavior metrics into the personality profile includes associating the plurality of behavior metrics with one or more behavior dimensions including at least one of:
a health dimension;
a finance dimension;
a mobility dimension;
an interests dimension;
a sociability dimension; or
a personal identity dimension.

18. The one or more tangible non-transitory computer-readable storage media of claim 17, wherein converting the plurality of behavior metrics into the personality profile includes generating, based on the plurality of behavior metrics associated with the one or more behavior dimensions, a plurality of lifestyle index values and a plurality of brand personality values.

19. The one or more tangible non-transitory computer-readable storage media of claim 16, the computer process further comprising:
generating an evidence confidence rating for the user data based on an origin-based interest scale indicating a level of interest associated with the user data based on how the user data originated; and
weighing the user data or the categorized user data based on the evidence confidence rating.

20. The one or more tangible non-transitory computer-readable storage media of claim 19, the computer process further comprising:
generating the evidence confidence rating for the user data based on a category-based interest scale indicating the level of interest associated with the user data based on a behavioral insight category associated with the user data; and
weighing the user data or the categorized user data based on the evidence confidence rating.
